(19) United States
(12) Patent Application Publication
(10) Pub. No.: US 2019/0303940 A1
(43) Pub. Date: Oct. 3, 2019

(54) SYSTEMS AND METHODS FOR DETECTING AND REPORTING FRAUD IN TRANSACTIONS

(71) Applicant: Wells Fargo Bank, N.A., San Francisco, CA (US)

(72) Inventors: Thomas R. Miller, Levittown, PA (US); Lynn Mingone, San Francisco, CA (US); Tanisha Patterson-Powe, Huntersville, NC (US); Benjamin Shepherd, San Francisco, CA (US); Holland Stimac, San Francisco, CA (US); Benjamin Taylor, Williston, VT (US); Leonard J. Valentino, Stamford, CT (US)

(21) Appl. No.: 15/937,377

(22) Filed: Mar. 27, 2018

(51) Int. Cl. G06Q 20/40

(52) U.S. Cl. CPC G06Q 20/4016; G06Q 20/407

(57) ABSTRACT

A method comprises receiving, by a provider computing system from a customer computing system, a transaction request for processing a transaction. The transaction includes a transaction information. The provider computing system determines that the transaction information is complete transaction information. The provider computing system determines a transaction history associated with a party to the transaction request. A portion of the transaction history is not accessible by the customer computing system. The provider computing system determines a possible instance of fraud based on the transaction history and the complete transaction information. The provider computing system generates a UAR. Furthermore, the provider computing system populates a blank field of the UAR, based on the analysis of the transaction history with the complete transaction information. The provider computing system transmits to the customer computing system, a fraud alert which is displayed on a personnel device of a customer personnel associated with the customer.

### BACKGROUND

Rising instances of identity theft, impersonation, ransom ware, phishing and other scams has made it particularly difficult to detect fraudulent transactions. The issue is of particular concern for transactions involving foreign financial institutions. For example, a foreign financial institution may originate a transaction to a local (e.g., U.S. based) financial institution. The foreign financial institution may be a customer of the local financial institution and may be requesting a transaction to be processed by the local financial institution, which was originated by a client of the foreign financial institution. However, in many instances, the foreign financial institution may not be in possession of all the information or a detailed transaction history associated with similar transactions from the client. In the absence of all the information, it may be difficult for the foreign financial institution computing system to detect possibility of fraud in the transaction.

### SUMMARY

Arrangements described herein relate generally to systems and methods for detecting fraud in financial transactions, and in particular to provider computing systems that analyze a transaction history of a transaction originated by a foreign institution to determine if information pertaining to the transaction is complete, using the transaction history to determine possibility of fraud, and inserting missing information into an unusual activity report (UAR) corresponding to the transaction using information obtained from the transaction history not available to the foreign institution.

In some arrangements, a method of analyzing fraud in a transaction comprises receiving, by a provider computing system from a customer computing system, a transaction request for processing a transaction. The transaction includes a transaction information. The provider computing system determines using information stored in a transaction database, that the transaction information is complete transaction information. The provider computing system determines a transaction history associated with a party to the transaction request. A portion of the transaction history is not accessible by the customer computing system. The provider computing system determines a possibility of fraud in the transaction based on the transaction history and the complete transaction information. The provider computing system generates a UAR. Furthermore, the provider computing system populates a blank field of the UAR, based on the analysis of the transaction history with the complete transaction information. The provider computing system transmits to the customer computing system, a fraud alert. The fraud alert is displayed at least on a personnel device of a customer personnel associated with the customer computing system.

In some arrangements, a provider computing system comprises a network interface structured to facilitate data communication via a network, a memory, and a processing circuit comprising a processor. The processing circuit is configured to receive, from a customer computing system, a transaction request for processing a transaction. The transaction includes a transaction information. The processing circuit determines using information stored in a transaction database, that the transaction information is incomplete. The processing circuit automatically inserts, using information stored in the transaction database, additional information into the transaction information so as to generate a complete transaction information. The processing circuit determines a possible instance of fraud in the transaction based on the transaction history and the complete transaction information. In response to determining that the possible instance of fraud in the transaction, the processing circuit stops the transaction. Furthermore, the processing circuit transmits to the customer computing system, a fraud alert. The fraud alert is displayed at least on a personnel device of a customer personnel associated with the customer computing system.

In some arrangements, a non-transitory processor-readable medium having processor-readable instructions stored thereon, such that when executed by a processor of a provider computing system, causes the provider computing system to perform operations. The operations comprise receiving from a customer computing system, a transaction request for processing a transaction. The transaction includes a transaction information. The processing circuit determines using information stored in a transaction database, that the transaction information is complete transaction information. The processing circuit determines a transaction history associated with a party to the transaction request. A portion of the transaction history is not accessible by the customer computing system. The processing circuit determines a possible instance of fraud in the transaction based on the transaction history and the complete transaction information. The processing circuit generates a UAR. Furthermore, the processing circuit system populates a blank field of the UAR, based on the transaction history and the complete transaction information. The processing circuit transmits to the customer computing system, a fraud alert. The fraud alert is displayed at least on a personnel device of a customer personnel associated with the customer computing system.

In some arrangements, a method of analyzing and reporting fraud in a transaction comprises receiving, by a provider computing system from a customer computing system, a transaction request for processing a transaction. The transaction includes a transaction information. The provider computing system determines a possible instance of fraud in the transaction based a transaction history associated with the transaction and the transaction information. The provider computing system stops the transaction. The provider computing system generates a UAR. The provider computing system determines if the UAR includes missing fields. In response to determining that the UAR includes missing fields, the provider computing system determines t from the transaction history for information corresponding to the missing fields. The provider computing system inserts from the transaction history, additional information into the unusual activity report so as to fill any missing fields of the UAR. The UAR is transmitted by the provided computing system to the customer computing system. The UAR is displayed at least on a personnel device of a customer personnel associated with the customer computing system.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a diagram of a system for detecting fraud in a transaction by a provider computing system, according to some arrangements.

FIG. 2 is a schematic block diagram of a customer computing system and a provider computing system, according to some arrangements.

FIG. 3 is a schematic flow diagram illustrating a method for detecting fraud in a transaction and providing a fraud alert to a customer computing system, according to some arrangements.

FIG. 4 is a schematic flow diagram illustrating a method for detecting fraud in a transaction and providing a fraud alert and a UAR to a customer, according to some arrangements.

FIG. 5 is a schematic flow diagram illustrating a method for detecting fraud in a transaction, analyzing transaction history to find any missing information in a UAR, and filling missing fields of the UAR with the missing information, according to some arrangements.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Arrangements described herein relate generally to systems and methods for detecting fraud in transactions (e.g., financial transactions), and in particular to provider computing systems that analyze a transaction history of a transaction originated by a foreign institution to determine if information pertaining to the transaction is complete, use the transaction history to determine possibility of fraud, generate a UAR corresponding to the transaction and populate any missing fields of the UAR using information obtained from the transaction history not available to the foreign institution.

In some arrangements, a method of analyzing fraud in a transaction comprises receiving, by a provider computing system from a customer computing system, a transaction request for processing a transaction. The transaction includes a transaction information. The provider computing system determines using information stored in a transaction database, that the transaction information is complete transaction information. The provider computing system determines a transaction history associated with a party to the transaction request. A portion of the transaction history may not be accessible by the customer computing system. The provider computing system determines a possible instance of fraud in the transaction based on the transaction history and the complete transaction information. The provider computing system generates a UAR. Furthermore, the provider computing system populates a blank field of the UAR, based on the analysis of the transaction history with the complete transaction information. The provider computing system transmits to the customer computing system, a fraud alert. The fraud alert is displayed at least on a personnel device of a customer personnel associated with the customer computing system.

In various arrangements, the provider computing system inserts from the transaction database, additional transaction information into the UAR not included in the transaction information. The provider computing system transmits to the customer computing system, the UAR. In some arrangements, prior to determining that the transaction information is complete transaction information, the provider computing system determines that the transaction information is incomplete. The provider computing system automatically inserts additional information into the transaction information using information stored in the transaction database, so as to generate the complete transaction information. The customer computing system may be associated with a foreign financial institution.

In some arrangements, the complete transaction information comprises at least one of a name of the originator of the transaction, a name of the beneficiary of the transaction, a transaction origin location, a transaction destination location, spelling of data included in the complete transaction information, one or more fraudulent accounts associated with the transaction, a time zone of the transaction, contact information associated with transaction, originator account number, or a beneficiary account number. In other arrangements, in response to determining the possible instance of fraud in the transaction, the provider computing system stops the transaction for a predetermined time. In various arrangements, the provider computing system determines if a cancel transaction notification is received by the provider computing system from the customer computing system within the predetermined time. In response to not receiving the cancel transaction notification within the predetermined time, the provider computing system processes the transaction.

In some arrangements, the fraud alert may comprise the UAR. In various arrangements, the provider computing system links the customer computing system and the provider computing system with a unique code associated with the transaction. The unique code may include at least one of a customer identifier code (e.g., a bank identifier code such as a SWIFT® code) and a transaction number. Furthermore, the fraud alert may comprise at least one of a customer identifier code message (e.g., a SWIFT® message), a freeform alert and an inquiry. In some arrangements, the UAR is non-editable. In some arrangements, the provider computing system updates a transaction history of at least one of a customer associated with the customer computing system or an originator of the transaction from the complete transaction information. In various arrangements, the provider computing system updates at least one of an outgoing report or a dashboard with the complete transaction information. In some arrangements, the provider computing system transmits to a communication portal associated with the customer computing system, the fraud alert. In other arrangements, the provider computing system receives from the communication portal, a transaction instruction instructing the provider computing system to at least one of proceed with the transaction or stop the transaction. In still other arrangements, the provider computing system transmits to a fraud management department associated with provider computing system, the fraud alert.

Various arrangements of the systems and methods for analyzing and reporting fraud in digital transactions described herein may provide several benefits including, for example: (1) detecting fraud using information that may not be available with the customer (e.g., a foreign financial institution) requesting the transaction; (2) automatically inserting information in an otherwise incomplete UAR so as to provide more comprehensive information on the transaction; (3) automatic generation of reports and fraud alerts; and (4) proactively stopping the transaction on determination of a possible instance of fraud, and rapidly conveying a fraud alert to the customer, thereby preventing fraudulent transactions from being processed. In addition, various arrangements described herein solve the technical problem of detecting fraud in transactions using information that is not available to an institution initiating a transaction by leveraging a plurality of customer interaction data available to a provider (e.g., a provider of financial services) that may not be available to a customer (e.g., a foreign financial institution) of the provider. In this manner, systems and methods described herein proactively detect and prevent fraudulent transactions which otherwise, would be processed due to information or data not available with the customer of the provider.

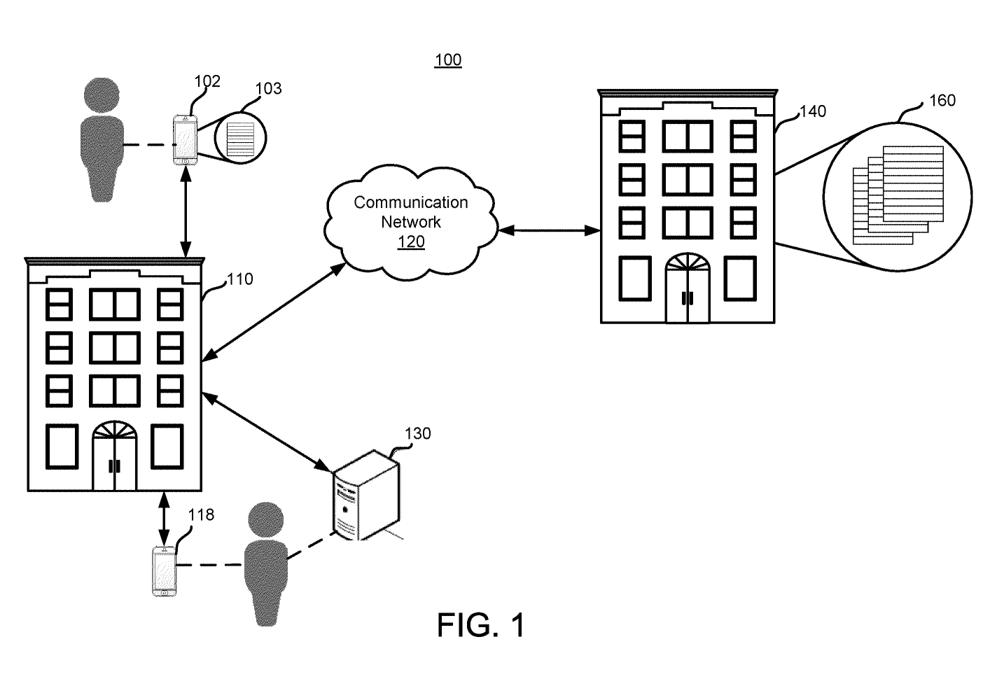

FIG. 1 is a diagram of an example system 100 for analyzing a transaction (e.g., a financial transaction) originated by a customer 110 for fraud. The customer 110 may include, for example, a foreign financial institution (e.g., a foreign bank), a foreign vendor, a foreign company, etc. As used herein, the term “foreign” implies that the customer 110 is located outside the country a provider 140 (e.g., a provider of financial services) is based in. Although FIG. 1 shows the customer 110 as including a brick and mortar location, in some arrangements, the customer 110 may include a virtual entity or an online institution. The customer 110 requests or otherwise originates a transaction which is communicated to a provider 140 through a communication network 120. For example, customer 110 may receive a request from a user via a user device 118 (e.g., a mobile device) or a server 130 associated with the user to process an offshore financial transaction, for example a payment to be made to a local beneficiary (e.g., a beneficiary located within the country the provider 140 is based in). The user may include an individual user or an entity (e.g., a business) who is a client of the customer 110. In some instances, the transaction may be a fraudulent transaction. For example, the transaction may be initiated by an entity impersonating the user, for example a scammer, an identity thief, etc. In other arrangements, the user may be unknowingly requesting a payment to a beneficiary associated with fraudulent transaction. In still other arrangements, the user and/or the beneficiary may be involved in fraud, illegal businesses or terrorist activities. In particular arrangements, the customer 110 may not have enough information about the transaction (e.g., a transaction database thereof may be incomplete) to determine that the transaction may be fraudulent, and requests the provider 140 to process the fraudulent transaction.

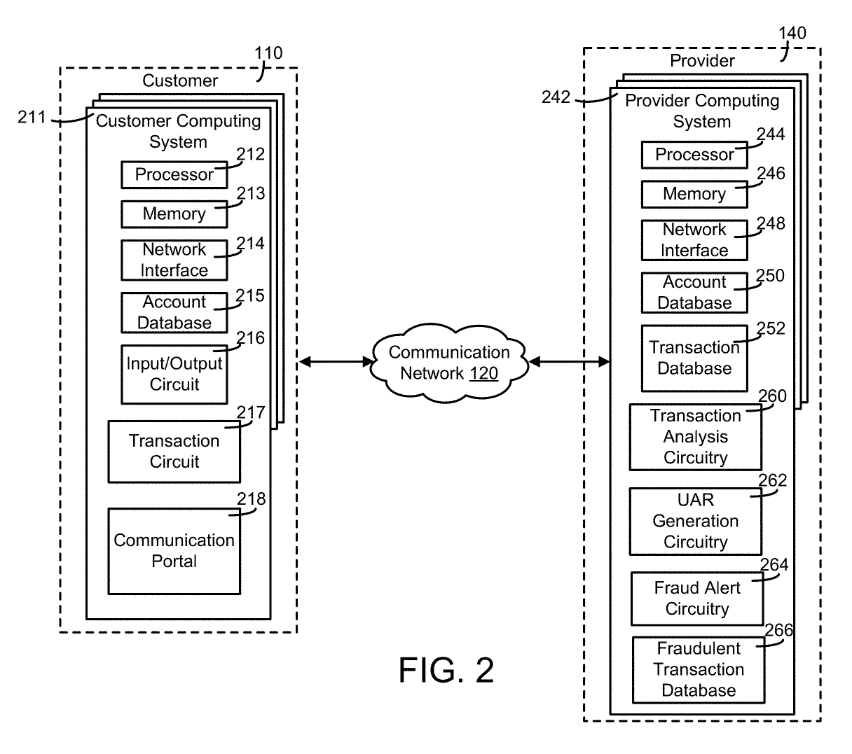

The provider 140 may include, for example, a provider of financial services, such as financial institution. FIG. 1 shows the provider 140 as a brick and mortar facility, but in some arrangements, the provider 140 may include an online only provider. The customer 110 may be associated with a customer computing system (e.g., the customer computing system 211, as described with respect to FIG. 2), for communication with the provider 140 (e.g., a provider computing system 242, as described with respect to FIG. 2), via the communication network 120. The communication network 120 is any suitable Local Area Network (LAN) or Wide Area Network (WAN). For example, the communication network 120 can be supported by Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), 802.11X, ZigBee, Bluetooth, Wi-Fi, any suitable wired network, combination thereof, and/or the like. The communication network 120 is structured to permit the exchange of data, values, instructions, messages, and the like between the customer 110 (e.g., the customer computing system 211 of FIG. 2) and the provider 140 (e.g., the provider computing system 242 of FIG. 2).

An information database 160 may be available which may store a transaction history of the customer 110. For example, the information database 160 may store information of previous transactions originated from the customer 110, processed by the provider 140, initiated by the user, and/or received by a beneficiary of the transaction. The transaction information may include detailed information of transaction information associated with the user. Such information may include but is not limited to a name of the originator of the transaction (e.g., the name of the user), a name of the beneficiary of the transaction, a transaction origin location, a transaction destination location, a time zone of the transaction, contact information associated with transaction, originator account number, and beneficiary account number. In some arrangements, at least a portion of the information available to the provider 140 may not be available to the customer 110.

A customer personnel, for example a risk counterpart personnel or a fraud department representative who may be in charge of being notified of possible fraudulent transactions and/or handling fraudulent transactions, may be in communication with the customer 110 through a personnel device 102. In some arrangements, the appropriate customer personnel to be notified of a possible fraudulent transaction may be based on a monetary value, or any other parameter of the transaction. For example, for a transaction having a monetary value of less than $100,000 or $1 Million, the customer personnel to be notified may include a risk counterpart personnel or a fraud department representative associated with the customer 110. For a transaction having a monetary value of $100,000 or more, $1 Million or more, and/or a possible instance of the transaction being associated with a terrorist organization or plot, the customer personnel to be notified may include a cybersecurity chief, a treasurer and/or a Chief Financial Officer associated with the customer 110.

The personnel device 102 may include, for example a mobile phone (e.g., an iPHONE®, an ANDROID® phone, a WINDOWS® phone, a SYMBIAN® phone or the likes), a tablet computer, a personal computer (e.g., a desktop or a laptop), a smart TV, a smart watch, a gaming system, an IP TV box, or any other user device. For example, the customer personnel may register or sign-up for a fraud alert service with the provider 140 through the user device 118. This may load a mobile communication portal application 103 on the personnel device 102, through which the provider 140 may notify the customer personnel, and thereby the customer 110 of a possible instance of fraud in the transaction, as described in further detail herein.

The provider 140 may receive a request from the customer 110 to process a transaction. The transaction includes a transaction information including but not limited to a name of the originator of the transaction (e.g., the name of the user), a name of the beneficiary of the transaction, a transaction origin location, a transaction destination location, a time zone of the transaction, contact information associated with transaction, originator account number, and beneficiary account number. The provider 140 may determine using information stored in the information database 160, that the transaction information is complete transaction information or that the transaction information is incomplete. Furthermore, the provider 140 may determine a transaction history associated with a party to the transaction request.

A portion of the transaction history may not be accessible to the customer 110. For example, the transaction history stored in the financial information database 160 corresponding to the customer 110, the user, and/or the beneficiary of the transaction may include more detailed information about previous corresponding transactions, which may not be available to the customer 110. For example, the user may also be a client of the provider 140, and the financial information database 160 may include information associated with the user not available to the customer 110. In other arrangements, the provider 140 may have derived extra information during processing of previous transactions originated by the customer 110 associated with the user, which may not have been available with the customer 110. In some arrangements, an account associated with the user and/or the beneficiary of the transaction may be flagged for fraud by the provider 140, thereby indicating a possible instance of fraud in the present transaction.

The provider 140 may determine a possible instance of fraud in the transaction from the transaction history and the complete transaction information. If a possible instance of fraud is detected, the provider 140 may generate a UAR. Furthermore, the provider 140 may populate one or more blank fields of the UAR, based on the analysis of the transaction history with the complete transaction information. The provider 140 may transmit a fraud alert to the customer 110 if a possible instance of fraud is detected. For example, the provider 140 may transmit the fraud alert to the mobile communication portal application 103 on the personnel device 102 so as to notify the customer personnel associated with the customer 110 of the possible instance of fraud in the transaction. In some arrangements, the fraud alert may include the UAR.

In various arrangements, the provider 140 may insert from the financial information database 160, additional transaction information into the UAR not included in the transaction information. For example, the provider 140 may populate one of more blank fields of the UAR with additional information obtained from the complete transaction information. The provider 140 may transmit to the customer 110, the complete UAR, for example. In some arrangements, the UAR may be non-editable so to prevent any changes made thereto once the UAR has been generated. In some arrangements, if the provider 140 determines that the transaction information is incomplete, the provider 140 may insert additional information into the transaction information using information stored in the financial information database 160, so as to generate the complete transaction information.

In some arrangements, the complete transaction information comprises at least one of a name of the originator of the transaction, a name of the beneficiary of the transaction, a transaction origin location, a transaction destination location, spelling of data included in the complete transaction information, one or more fraudulent accounts associated with the transaction, a time zone of the transaction, contact information associated with transaction, originator account number, or a beneficiary account number.

In other arrangements, if the provider 140 determines a possible instance of fraud in the transaction, the provider 140 stops the transaction for a predetermined time. The provider 140 may determine if a cancel transaction notification is received by the provider 140 from the customer 110 within the predetermined time. For example, the customer personnel may be notified via the mobile communication portal application 103 on the personnel device 102 to respond to the fraud alert within a predetermined time, for example 30 mins, 1 hour, 2 hours, 4 hours, 6 hours, 12 hours, 1 day, 2 day or any other suitable time period. If the provider 140 does not receive the cancel transaction notification within the predetermined time (e.g., from the personnel device 102) or the customer personnel notifies the provider 140 via the communication portal 218 that the financial transaction should be processed, the financial institution 140 may process the transaction. For example, the provider 140 may receive from the mobile communication portal application 103, a transaction instruction instructing the provider 140 to at least one of proceed with the transaction or stop the transaction.

In some arrangements, the fraud alert may comprise the UAR. In various arrangements, the provider 140 and the customer 110 may be linked with a unique code associated with the transaction. The unique code may include at least one of a customer identifier code (e.g., a bank identifier code such as SWIFT® code) and a transaction number. Furthermore, the fraud alert may additionally or alternately comprise at least one of a bank identifier code message (e.g., a SWIFT® message), a freeform alert and an inquiry. In some arrangements, the provider 140 may update a transaction history associated with the customer 110 or an originator of the transaction (e.g., the user) from the complete transaction information. In other arrangements, the provider 140 updates at least one of an outgoing report and a dashboard with the complete transaction information. In some arrangements, the provider 140 may transmit the fraud alert to a fraud management department associated with provider 140, for example to initiate further investigation of the transaction.

FIG. 2 is a diagram of an exemplary customer computing system 211 associated with the customer 110, and a provider computing system 242 which may be operated by the provider 140 of the system 100 set forth in FIG. 1, according to some arrangements. The provider 140 may include, for example, a provider of financial services such as one or more of a bank branch, a loan office, a mortgage office, a financial service office, a retail office, an ATM location, a combination thereof and/or the like. The provider 140 provides products and services (e.g., financial products) such as, but not limited to, credit card accounts, mobile wallet, checking/savings account, retirement accounts, mortgage accounts, loan accounts, investment and financial accounts, and the like to a user (e.g., the user) via the provider computing system 242. The provider computing system 242 includes a processor 244 and a memory 246. The processor 244 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 246 (e.g., Random Access Memory (RAM), Read-Only Memory (ROM), Non-volatile RAM (NVRAM), Flash Memory, hard disk storage, etc.) stores data and/or computer code for facilitating at least some of the various processes described herein. The memory 246 includes tangible, non-transient volatile memory, or non-volatile memory. The memory 246 may include a non-transitory processor 244 readable medium having stores programming logic that, when executed by the processor 244, controls the operations of the provider computing system 242. In some arrangements, the processor 244 and the memory 246 form various processing circuits described with respect to the provider computing system 242 (e.g., the transaction analysis circuitry 260, the UAR generation circuitry 262, and the fraud alert circuitry 264).

As shown, the provider computing system 242 includes a network interface 248. The network interface 248 is structured for sending and receiving data over the communication network 120 (e.g., to and from the customer computing system 211, etc.). Accordingly, the network interface 248 includes any of a cellular transceiver (for cellular standards), local wireless network transceiver (for 802.11X, ZigBee, Bluetooth, Wi-Fi, or the like), wired network interface, a combination thereof (e.g., both a cellular transceiver and a Bluetooth transceiver), and/or the like.

The provider computing system 242 includes an account database 250 that stores customer information (e.g., information related to the customer 110) and account information relating to one or more accounts held by users (e.g., the user). For example, the account database 250 may be included in the information database 160. In this regard, more than one provider (such as, but not limited to, the provider 140) with an associated provider computing system (such as, but not limited to, the provider computing system 242) can be communicably coupled to the components of FIG. 2 over the communication network 120 to access the accounts held by the user and/or the customer 110. Information stored in the account database 250 may include but is not limited to customer name, address, contact information, account information, transaction history specific to the customer 110 or the user, loan information, mortgage information, or any other information relevant to the customer 110 and/or the user.

The provider computing system 242 may include a transaction database 252 for storing transactions related to one or more customers of the provider 140 (e.g., the customer 110). The transaction database 252 may be included in the financial information database 160. The transaction database 252 may include a profile of the customer 110, the originator of the transaction (e.g., the user), or each previously processed transaction associated with the customer 110 and/or the originator of the transaction. The profile may include detailed information on all the transactions associated with the customer 110, and in particular, information on financials transactions originating from the customer 110 corresponding to the user and/or the beneficiary of the transaction. The transaction database 252 may also include information on any red flags or previous warnings associated with one or more transactions associated with the customer 110, for example if any particular transactions were flagged for fraud.

The provider computing system 242 includes a transaction analysis circuitry 260. The transaction analysis circuitry 260 is configured to receive a transaction request from the customer computing system 211 to process a transaction which includes a transaction information. The transaction analysis circuitry 260 may also be configured to analyze the transaction information using information stored in the transaction database 252 to determine if the transaction information is complete. The transaction analysis circuitry 260 may also be configured to determine a transaction history associated with a party to the transaction request, for example a transaction history associated with the customer 110, the user and/or a beneficiary of the transaction. A portion of the transaction history may not be accessible by the customer computing system 211, i.e., may not be available in an account database 215 associated with the customer computing system 211. For example, the transaction database 252 may include additional information pertaining to the transaction, e.g., via previous transactions initiated by the user through other customers of the provider 140, previous transaction patterns, transaction amounts, and/or transaction beneficiary information.

In some arrangements, if it is determined that the transaction information received from the customer computing system 211 is incomplete, the transaction analysis circuitry 260 may be configured to insert additional information into the transaction information, for example additional information obtained from the transaction database 252, so as to generate the complete transaction information. The transaction analysis circuitry 260 may also be configured to update a transaction history of at least one of the customer 110 associated with the customer computing system 211, and or an originator of the transaction (e.g., the user). In other arrangements, the transaction analysis circuitry 260 may be configured to update, or provide the complete transaction information to update and outgoing report and/or a dashboard (e.g., a dashboard included in the provider computing system 242 which tracks in process transactions).

In some arrangements, the transaction analysis circuitry 260 may also be configured to link the customer computing system 211 and the provider computing system 242 with a unique code associated with the transaction. For example, the unique code may comprise a bank identifier code (e.g., a SWIFT® code), a transaction number and/or a token (e.g., an encrypted token) generated by the transaction analysis circuitry 260 that links the customer computing system 211 and the provider computing system 242 with the account number of the fraudulent transaction.

The transaction analysis circuitry 260 is configured to determine a possible instance of fraud in the transaction based on the transaction history and the complete transaction information. In some arrangements, the complete transaction information may include but is not limited to a name of the originator of the transaction, a name of the beneficiary of the transaction, a transaction origin location, a transaction destination location, spelling of data included in the complete transaction information, one or more fraudulent accounts associated with the transaction, a time zone of the transaction, contact information associated with transaction, originator account number, and beneficiary account number.

Expanding further, if the transaction analysis circuitry 260 detects spelling errors in the name of the originator of the transaction (e.g., the user), the beneficiary of the transaction and/or any data included in the complete transaction information, and/or detects that name of the originator of the transaction is different from an originator normally associated with such transactions, the transaction analysis circuitry 260 may be configured to determine that there is a possible instance of fraud in the transaction. In some arrangements, if the transaction analysis circuitry 260 determines that the transaction was originated from a location which is different from the origin location associated with the originator (e.g., the user generally originates transaction from London, but the present transaction was originated from Moscow), the transaction analysis circuitry 260 may be configured to flag the transaction as being possibly fraudulent. In other arrangements, if the transaction analysis circuitry 260 determines that the transaction destination location associated with the transaction is different from a usual transaction destination location of corresponding transactions determined from the complete transaction information, the transaction analysis circuitry 260 may be configured to flag the transaction as possibly fraudulent. Furthermore, the transaction analysis circuitry 260 may also be configured to flag the transaction as being possibly fraudulent if an account number associated with the originator of the transaction (e.g., the user) and/or the beneficiary of the transaction does not match the account number associated with the originator and/or the beneficiary in the transaction history stored in the transaction database 252. Moreover, the transaction analysis circuitry 260 may further be configured to flag the transaction as being possibly fraudulent if the provider computing system 242 possesses information received from another customer, or partner provider that the originator and/or beneficiary of the transaction is associated with other fraudulent transactions, illegal activities and/or terrorist activities.

In some arrangements, the transaction analysis circuitry 260 may also be configured to determine that a time zone associated with the transaction is suspicious and may determine a possible instance of fraud in the transaction. For example, the transaction may have been initiated in China outside of regular business hours, or late in the night (e.g., between 12 am and 6 pm), which may be different from time zone of previous transactions associated with the originator of the transaction. In some arrangements, the provider computing system 242 may also include a fraudulent transaction database 266 which includes detailed information on all fraudulent transactions that have been detected by the provider computing system 242. In such arrangements, the transactional analysis circuitry 260 may also be configured to determine from the fraudulent transaction database 266any data included in the complete transaction information, one or more accounts associated with the transaction, contact information associated with transaction, originator account number, and beneficiary account number corresponds to a fraudulent transaction stored in the fraudulent transaction database 266. If such a correspondence is detected, the transaction analysis circuitry 260 may be configured to determine a possible instance of fraud in the transaction.

The transaction analysis circuitry 260 is operably coupled to one or more of the components of the provider computing system 242. For example, the transaction analysis circuitry 260 may be coupled to the communication network interface 248 for communicating with one or more of the customer computing system 211 and/or a communication portal 218 of the customer computing system 211 which may be in communication with the mobile communication portal application 103 on the personnel device 102, via the communication network 120. In some arrangements, the transaction analysis circuitry 260 may be configured to request and receive information on whether the customer 110 is enrolled in a fraud detection and alert program, for example from the account database 250 and/or the transaction database 252.

In some arrangements, the provider computing system 242 also includes a UAR generation circuitry 262. The UAR generation circuitry 262 may be operatively coupled to the transaction analysis circuitry 260, and is configured to generate a UAR, for example in response to the transaction analysis circuitry 260 determining a possible instance of fraud in the transaction. The UAR may include a physical report or a virtual report that may include detailed information on the transaction and/or one or more reasons why the transaction was determined to be possibly fraudulent. In various arrangements, the UAR generation circuitry 262 may also be configured to populate one or more blank fields of the UAR based on the analysis of the transaction history with the complete transaction information. For example, the UAR generation circuitry 262 may be configured to generate the UAR based on initial information on the transaction provided by the customer computing system 211. The initial information provided by the customer computing system 211 may not include all the information corresponding to the transaction, for example because the customer computing system 211 is not in possession of the information. The UAR generation circuitry 262 may also be configured to analyze the UAR to determine if one of more fields of the UAR are blank, or otherwise data corresponding to the transaction is missing from the UAR. If the UAR generation circuitry 262 determines that one or more fields of the UAR are blank, the transaction analysis circuitry 260 may be configured to analyze the complete transaction information corresponding to the transaction to obtain information corresponding to the blank fields. The UAR generation circuitry 262 may be configured to then populate one or more blank fields of the UAR with the information obtained by the transaction analysis circuitry 260 so as to provide a comprehensive UAR including additional information corresponding to the transaction which was not provided by the customer computing system 211. In some arrangements, the UAR may be non-editable, so as to prevent any changes thereto.

In various arrangements, the provider computing system 242 may also include a fraud alert circuitry 264. The fraud alert circuitry 264 may be configured to transmit a fraud alert to the customer computing system 211 if the transaction analysis circuitry 260 determines that the transaction may be possibly fraudulent. The fraud alert may include, for example the complete UAR, a bank identifier code message (e.g., a 199 SWIFT® message), a freeform alert and/or an inquiry. The fraud alert may additionally or alternatively also include an email, a text message or a phone call, for example to the personnel device 102. In some arrangements, the fraud alert circuitry 264 may also be configured to transmit the fraud alert to the fraudulent transaction database 266, for example to update the fraudulent transaction database 266 with the complete information of the present transaction. In still other arrangements, the fraud alert circuitry 264 may also be configured to transmit the fraud alert to a fraud management department associated with the provider 140. This may allow the fraud management department to proactively take loss prevention measures, escalate the transaction for review by risk mitigation personnel and/or cybersecurity personnel, and investigate the fraudulent transaction. In particular arrangements, the user, who may be the subject of the fraudulent transaction, may also be client of the provider 140. In such arrangements, the provider computing system 242 may also be configured to send a fraud alert to the user, for example via a mobile client application installed on the user device 118, an email, a text alert and/or a phone call.

In some examples, the transaction analysis circuitry 260, the UAR generation circuitry 262 and the fraud alert circuitry 264 are implemented with the processor 244. For example, the transaction analysis circuitry 260, the UAR generation circuitry 262 and the fraud alert circuitry 264 can be implemented as a software applications stored within the memory 246 and executed by the processor 244. Accordingly, such examples can be implemented with minimal or no additional hardware costs. However, other implementations may rely on dedicated hardware specifically configured for performing operations of the transaction analysis circuitry 260, the UAR generation circuitry 262 and the fraud alert circuitry 264. In some arrangements, the provider computing system 242 includes or is otherwise operatively coupled to the financial information database 160.

As shown, the customer 110 operates or is associated with the customer computing system 211. In some arrangements, the customer computing system 211 includes a processor 212, a memory 213, and a network interface 214. The processor 212 may be implemented as a general-purpose processor, an ASIC, one or more FPGAs, a DSP, a group of processing components that are distributed over various geographic locations or housed in a single location or device, or other suitable electronic processing components. The memory 213 may include a non-transitory, processor readable medium (e.g., RAM, NVRAM, ROM, Flash Memory, hard disk storage, etc.) stores data and/or computer code for facilitating the various processes described herein. Moreover, the memory 213 is or includes tangible, non-transient volatile memory or non-volatile memory. Accordingly, the memory 213 includes database components, object code components, script components, or any other type of information structure for supporting the various activities and information structures described herein.

The customer computing system 211 is shown to include various circuits and logic for implementing the activities described herein. More particularly, the customer computing system 211 includes one or more of an input/output circuit 216, a network interface 214, a transaction circuit 217 and/or the like. While various circuits, interfaces, and logic with particular functionality are shown, it should be understood that the customer computing system 211 includes any number of circuits, interfaces, and logic for facilitating the functions described herein. For example, the activities of multiple circuits are combined as a single circuit and implemented on a same processing circuit (e.g., the processor 212), as additional circuits with additional functionality are included.

The network interface 214 is configured for and structured to establish a communication session via the communication network 120 with the provider computing system 242. Accordingly, the network interface 214 is an interface such as, but not limited to, the network interface 248. The input/output circuit 216 is configured to receive user input from the user (e.g., an input to initiate the transaction) and provide information to the user. In this regard, the input/output circuit 216 is structured to exchange data, communications, instructions, etc. with an input/output component of the user device 118 and/or server 130. Accordingly, in some arrangements, the input/output circuit 216 includes an input/output device such as a display device, touchscreen, keyboard, microphone, a finger print reader, and/or the like. In some arrangements, the input/output circuit 216 may be in communication with the personnel device 102 so as to provide information on transaction thereto, and/or communicate a fraud alert received from the provider computing system 242. In some arrangements, the input/output circuit 216 includes communication circuitry for facilitating the exchange of data, values, messages, and the like between the input/output device and the components of the user device 118 and/or the personnel device 102. In some arrangements, the input/output circuit 216 includes machine-readable media for facilitating the exchange of information between the input/output device and the components of the user device 118 and/or the personnel device 102. In still another arrangement, the input/output circuit 216 includes any combination of hardware components (e.g., a touchscreen), communication circuitry, and machine-readable media.

The customer computing system 211 may also include an account database 215 including information corresponding to the user, the present transaction and/or one or more previous transactions associated with the user. In some arrangements, the information corresponding to the present transaction included in the account database 215 may not be complete, or otherwise comprehensive. The transaction circuit 217 is structured to generate and transmit a transaction request to the provider computing system 242, for example, via a communication portal 218 associated with the customer computing system 211, and in some arrangements, additionally with the personnel device 102 via the mobile communication portal application 103. The transaction request may include information corresponding to the transaction obtained from the account database 215 which, in some instances may be incomplete, as previously described herein.

The communication portal 218 is configured to provide an information interface and/or an interactive database to the customer personnel to receive updates regarding the transaction and/or a fraud alert associated with the transaction. In some arrangements, the communication portal 218 may only be available on the customer computing system 211. In other arrangements, the communication portal 218 may also be available on the personnel device 102, for example as the mobile communication portal application 103 or a server-based application executable on the personnel device 102. In this regard, the customer personnel may have to first download the application(s) prior to usage. In other arrangements, the mobile communication portal application 103 may be encoded into the memory 213 of the customer computing system 211 and/or a memory of the personnel device 102. In still other arrangements, the mobile communication portal application 103 may be a web-based interface application. In this configuration, the customer personnel may have to log onto or otherwise access the web-based interface before usage. In this regard, the mobile communication portal application 103 may be supported by a separate computing system comprising one or more servers, processors, network interface modules, etc. that transmit the applications for use to the personnel device 102. In certain arrangements, the mobile communication portal application 103 may include an Application Programming Interface (API) and/or a Software Development Kit (SDK) that facilitate integration of other applications. All such variations and combinations are intended to fall within the spirit and scope of the present disclosure. In some arrangements, the communication portal 218 and/or the mobile communication portal application 103 may be configured to receive authentication information from the customer personnel authorizing and/or reviewing the transaction, for example reviewing a fraud alert corresponding to the transaction. Such authentication information may include but is not limited to biometrics such as a thumbprint, facial recognition or retinal identification, a Personal Identification Number (PIN), a password, single factor or multifactor authentication and the likes. The authentication information may allow the provider computing system 242 to verify that the transaction was originated by or is being approved by the customer personnel associated with the customer computing system 211, for example by comparing the additional information with reference information or templates stored in the account database 250 and/or the transaction database 252 of the provider computing system 242.

As previously described herein, the provider computing system 242 (e.g., the fraud alert circuitry 264) may be configured to transmit the fraud alert to the communication portal 218 and/or the mobile communication portal application 103. In some arrangements, the provider computing system 242 (e.g., the fraud alert circuitry 264) may receive a transaction instruction form the customer computing system 211, for example via the communication portal 218 and/or the mobile communication portal application 103 to proceed with the transaction or stop the transaction. Expanding further, in some arrangements, in response to determining a possible instance of fraud in the transaction, the provider computing system 242 (e.g., the transaction analysis circuitry 260) may be configured to stop the transaction. The provider computing system 242 (e.g., the fraud alert circuitry 264) may also be configured to send the fraud alert to the customer computing system 211, for example via the communication portal 218 and/or the mobile communication portal application 103 to provide instructions on whether to keep the transaction on hold, stop the transaction or process the transaction. The provider computing system 242 may be configured to keep the transaction on hold, until specific instructions are received from the customer computing system 211 via the transaction instruction instructing the provider computing system 242 to stop or process the transaction. In some arrangements, the provider computing system 242 may be configured to stop the transaction until specific instructions are received from the customer computing system 211 (e.g., via the communication portal 218), if a monetary value of the transaction is above a monetary threshold (e.g., greater than or equal to $100,000 or $1 Million), or any data included in the complete information corresponding to the transaction is associated with an individual or organization perceived to be involved in fraud and/or terrorist activities.

In some arrangements, in response to determining the possible instance of fraud in the transaction, the provider computing system 242 (e.g., the transaction analysis circuitry 260) may be configured to stop the transaction for a predetermined time, for example 30 mins, 1 hour, 2 hours, 4 hours, 6 hours, 12 hours, 1 day, 2 day or any other suitable time period. Such a transaction may include, for example a transaction having a monetary value below the monetary threshold and otherwise not associated with a known fraudulent and/or terrorist individual or organization. The provider computing system 242 (e.g., the transaction analysis circuitry 260) may also be configured to determine if a cancel transaction notification is received by the provider computing system 242 (e.g., from the communication portal 218 and/or the mobile communication portal application 103 associated with the customer computing system 211) within the predetermined time. The cancel transaction notification may include instructions to cancel or stop the transaction, or otherwise put the transaction on hold. If the cancel transaction notification is received within the predetermined time, the provider computing system 242 may be configured to cancel the transaction, and send the associated UAR to the customer computing system 211 and/or the personnel device 102, and the fraud management department associated with the provider computing system 242. Moreover, the fraudulent transaction database 266 may be updated. However, if the provider computing system 242 does not receive the cancel transaction notification within the predetermined time, the provider computing system 242 may be configured to process the transaction.

In various arrangements, a fraudulent transaction may be processed, for example because of a cancel transaction notification not being received from the customer computing system 211, or in response to a transaction instruction received by the provider computing system 242 from the communication portal 218 or mobile communication portal application 103 associated with the personnel device 102 to process the transaction. In such arrangements, the provider computing system 242 (e.g., the fraud alert circuitry 264) may also be configured to provide post-fraud information to the customer computing system 211. Such post-fraud information may include but is not limited to information on local laws (e.g., financial rules and regulations imposed in the US), information on legal counsel, information on fund recovery, and any other information which may be useful for the customer 110 for reporting the fraudulent transaction and recovering any lost funds.

In some arrangements, if a transaction originating from the customer computing system 211 is flagged as potentially fraudulent, a UAR is generated and one or more blank fields thereof populated with the complete transaction information, as previously described herein regardless of whether the transaction is subsequently processed or canceled. In such arrangements, the UAR and/or any other fraud alert (e.g., a bank identifier code message, a free form inquiry and/or an alert) may be provided to the customer computing system 211, and/or customer personnel via the personnel device 102, and the fraud management department associated with the provider computing system 242 regardless of whether the transaction was processed or canceled. Moreover, the transaction database 252 and, in some arrangements, the fraudulent transaction database 266, an ongoing report and/or a dashboard may also be updated to include the UAR. Furthermore, the UAR may be non-editable as previously described herein, and may perpetually remain associated with the transaction or until it is determined that the transaction was legitimate.

In this manner, the provider computing system 242 is configured to detect the possibility of fraud in the transaction requested by the customer 110 (e.g., a foreign financial institution) using information available with the provider computing system 242 but not available with the customer computing system 211. The provider computing system 242 may be configured to instantaneously stop the possibly fraudulent transaction, automatically generate the complete UAR as previously described and instantaneously notify the customer computing system 211 of a fraud alert if a possibly fraudulent transaction is detected. This greatly reduces the reaction and response time to a possibly fraudulent transaction, which conventionally could take numerous days, and mitigates legal as well financial implications of the fraudulent transaction. In some arrangements, the provider computing system 242 (e.g., the transaction analysis circuitry 260) may also be configured to freeze an account associated with the fraudulent transaction, for example one or more accounts linked with an originator of the transaction (e.g., the user) and/or a beneficiary of the fraudulent transaction.

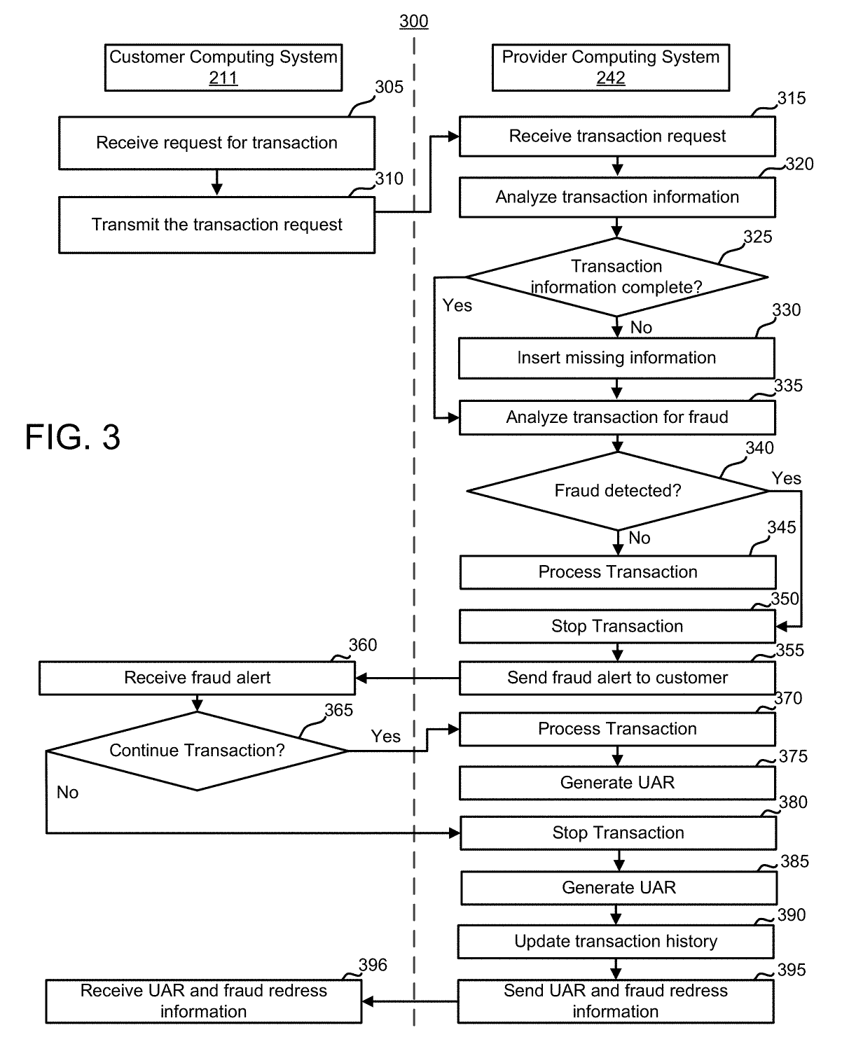

FIG. 3 is a flow diagram illustrating a method 300 for detecting and reporting fraud in a financial transaction between two financial institutions, for example the customer 110 and the provider 140, according to various arrangements. In some arrangements, the method 300 may be executed using circuitry of the provider computing system 242 using information stored in the account database 250 and/or the transaction database 252. The transaction may be initiated by a transaction initiating computing system which, in particular arrangements, may include the customer computing system 211. Referring to FIGS. 1-3, the method 300 is generally initiated when a transaction initiating computing system (e.g., the customer computing system 211) receives a request for a transaction, at 305. For example, the user or someone impersonating the user, i.e., perpetrating a fraudulent transaction, may request the transaction with the customer computing system 211. The customer computing system 211 may be associated with a foreign financial institution. The transaction initiating computing system transmits the transaction request to a provider computing system, at 310. For example, the customer computing system 211 transmits the transaction request to the provider computing system 242. The transaction request may include transaction information including details about the transaction, for example provided by the originator of the transaction (e.g., the user) and may be transmitted to the provider computing system 242 via the communication network 120.

The provider computing system receives the transaction request including the transaction information from the transaction initiating computing system, at 315. For example, the provider computing system 242 receives the transaction request from the customer computing system 211. The provider computing system analyzes the transaction information, at 320. For example, the provider computing system 242 may be configured to compare the transaction information with historical transaction information stored in the account database 250 and/or the transaction database 252. The provider computing system determines if the transaction information is complete, at 325. For example, the provider computing system 242 may be configured to determine a transaction history associated with a party to the transaction request (e.g., the user) wherein a portion of the transaction history is not accessible by the customer computing system 211. As previously described herein, the customer computing system 211 may not possess all the information about the transaction. This information may however be available with the provider computing system 242. If the transaction information is complete, the method 300 moves to operation 335. In some arrangements, in response to determining that the transaction information is incomplete, the provider computing system automatically inserts missing or otherwise additional information into the transaction information, at 330. For example, the provider computing system 242 may be configured to insert the additional information using information stored in the transaction database 252 so as to generate the complete transaction information.

The provider computing system determines a possible instance of fraud in the transaction based on the transaction history and the complete transaction information, at 335. For example, the provider computing system 242 may be configured to analyze the transaction for fraud. In some arrangements, the complete transaction information analyzed to determine a possibility of fraud by the provider computing system (e.g., the provider computing system 242) comprises at least one of a name of the originator of the transaction, a name of the beneficiary of the transaction, a transaction origin location, a transaction destination location, spelling of data included in the complete transaction information, one or more fraudulent accounts associated with the transaction, a time zone of the transaction, contact information associated with transaction, originator account number, or a beneficiary account number.

The provider computing system determines if detected possible instance of fraud is determined in the transaction, at 340. If no fraud is detected, the provider computing system may process the transaction, at 345. In response to determining a possible instance of fraud, the provider computing system may stop the transaction, at 350. In some arrangements, the provider computing system (e.g., the provider computing system 242) may be configured to stop the transaction for a predetermined time, for example 30 mins, 1 hour, 2 hours, 4 hours, 6 hours, 12 hours, 1 day, 2 days or any other suitable time period. In particular arrangements, the provider computing system (e.g., the provider computing system 242) may also be configured to link the customer computing system (e.g., the customer computing system 211) and the provider computing system with a unique code associated with the transaction. The unique code may include a bank identifier code (e.g., a SWIFT® code) and/or a transaction number associated with the transaction.

The provider computing system transmits a fraud alert to the transaction initiating computing system, at 355. In some arrangements, the fraud alert may comprise a bank identifier code message (e.g., a SWIFT® 199 message), a freeform alert and/or an inquiry, as described below herein. For example, the provider computing system 242 may be configured to transmit the fraud alert to the communication portal 218 associated with the customer computing system 211 or the mobile communication portal application 103 associated with the personnel device 102. The customer computing system receives the fraud alert, at 360. For example, the customer computing system 211 may receive the fraud alert on the communication portal 218 and/or the mobile communication portal application 103 of the personnel device 102. The transaction initiating computing system determines whether to process or cancel the transaction, at 365. For example, the customer personnel may review the transaction and determine if the transaction should be canceled or processed.

The provider computing system (e.g., the provider computing system 242) may be configured to receive from a communication portal (e.g., the communication portal 218) or a mobile communication portal application (e.g., the mobile communication portal 103), a transaction instruction instructing the provider computing system to at least one of proceed with the transaction or stop the transaction. For example, the customer computing system 211 may determine that the transaction is legitimate and transmit the transaction instruction the provider computing system 242 which includes a process request instructing the provider computing system 242 to process the transaction. In response to receiving the process request, the provider computing system may process the transaction, at 370. In some arrangements, the provider computing system (e.g., the provider computing system 242) may be configured to determine if a cancel transaction request is received from the transaction initiating computing system (e.g., the customer computing system 211) within the predetermined time. In response to not receiving the cancel transaction request from the customer computing system within the predetermined time, the provider computing system may be configured to process the transaction.

The provider computing system generates a UAR, at 375. In some arrangements, the provider computing system (e.g., the provider computing system 242) may be configured to automatically populate one or more blank fields of the UAR, based on the analysis of the transaction history with the complete transaction information. The UAR may be non-editable. In particular arrangements, the UAR may be automatically generated as soon as the possibility of a fraudulent transaction is detected (i.e., after stopping the transaction, at 350). In such arrangements, the fraud alert may include the UAR.

In response to receiving a cancel transaction request from the transaction initiating computing system, the provider computing system stops the transaction, at 380. For example, if the customer personnel confirms that the transaction is possibility fraudulent, and transmits a transaction instruction to the provider computing system 242 which includes a cancel transaction request, the provider computing system 242 automatically stops or otherwise cancels the transaction. The provider computing system may generate the UAR, at 385. For example, the provider computing system 242 may be configured to generate the UAR and may also be configured to automatically populate one or more blank fields of the UAR, based on the analysis of the transaction history with the complete transaction information, as previously described herein. In some arrangements, the provider computing system (e.g., the provider computing system 242) may update from the complete transaction information, a transaction history of at least one of the customer (e.g., the customer 110) associated with the customer computing system (e.g., the customer computing system 211), an originator of the transaction (e.g., the user) and/or a beneficiary of the transaction, at 390.

The provider computing system may transmit the UAR to the transaction initiating computing system, at 395. In some arrangements, the provider computing system (e.g., the provider computing system 242) may also transmit fraud redress information to the customer computing system (e.g., the customer computing system 211) along with the UAR. Such information may include, but is not limited to information on local laws (e.g., financial rules and regulations imposed in the US), information on legal counsel, information on fund recovery, and any other information which may be useful for the customer (e.g., the customer 110) for reporting and/or investigating the fraudulent transaction and recovering any lost funds. The transaction initiating computing system receives the UAR and optionally, the fraud redress information, at 396. In some arrangements, the provider computing system (e.g., the provider computing system 242) may also transmit the fraud alert to a fraud management department associated with provider computing system. In still other arrangements, the provider computing system may also update one or more outgoing reports and/or a dashboard associated with the provider computing system with the complete transaction information.

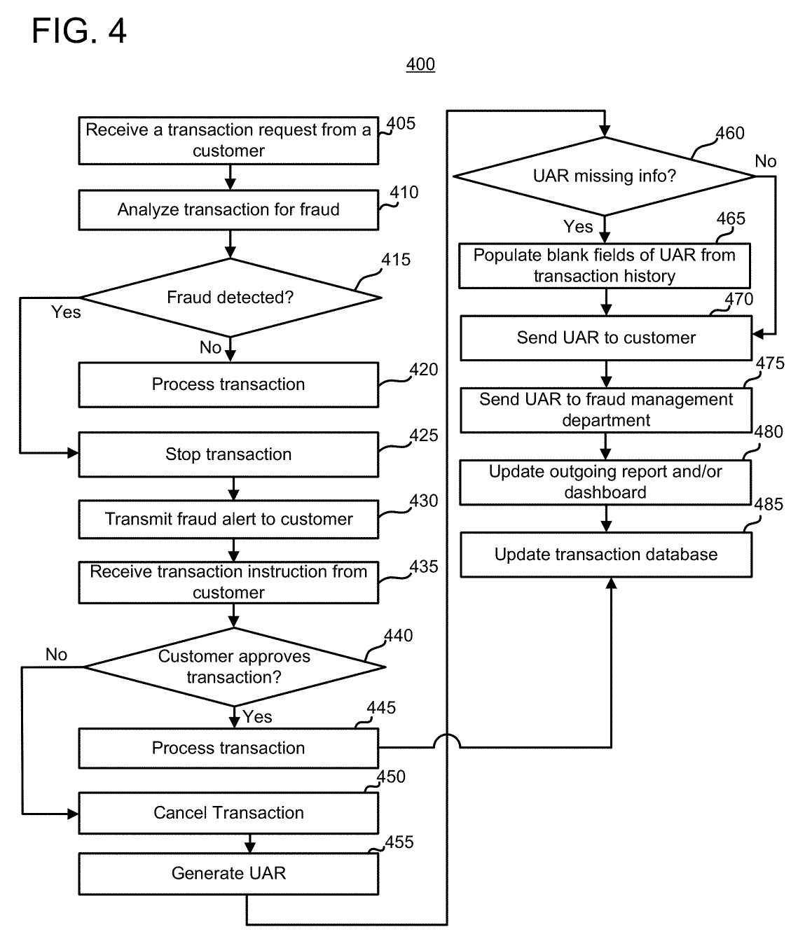

FIG. 4 is a flow diagram illustrating a method 400 for detecting and reporting fraud in financial transactions. In some arrangements, the method 400 may be executed using circuitry of the provider computing system 242 using information stored in the account database 250 and/or the transaction database 252. The method 400 is generally initiated when a provider computing system receives a transaction request from a customer, at 405. For example, the customer 110 may send a transaction request to provider computing system 242 via the customer computing system 211 (e.g., through the communication portal 218 or the mobile communication portal application 103). The transaction may be associated with a user (e.g., the user) and may be an authentic transaction generated by the user, a fraudulent transaction initiated by some impersonating the user or intended for a beneficiary defrauding the user into initiating the transaction.

The provider computing system analyzes the transaction for fraud, at 410. For example, the provider computing system 242 may be configured to analyze the transaction with a transaction history associated with a party to the transaction (e.g., the user and/or the customer 110), a portion of which may not be accessible by the customer 110 (e.g., not available on the account database 215 of the customer computing system 211). The provider computing system determines a possible instance of fraud in the transaction, at 415. If no fraud is detected in the transaction, the provider computing system may process the transaction, at 420. In response to determining a possible instance of fraud in the financial transaction, the provider computing system may stop the transaction, at 425. For example, the provider computing system 242 may be configured to automatically put the transaction on hold if a possible instance of fraud is detected in the transaction.

The provider computing system transmits a fraud alert to the customer 110, at 430. For example, the provider computing system 242 may be configured to transmit the fraud alert to the customer computing system 211 via the communication portal 218 and/or the mobile communication portal application 103 in response to a possibility of fraud being detected in the transaction. In some arrangements, the fraud alert may comprise a bank identifier code message (e.g., a SWIFT® 199 message), a freeform alert and/or an inquiry, as described below herein. In other arrangements, the fraud alert may include a UAR. In still other arrangements, the fraud alert may include an email, a text or phone call to the customer personnel, for example via the personnel device 102. The provider computing system receives a transaction instruction from the customer 110, at 440. For example, the customer personnel may send the transaction instruction through the mobile communication portal application 103 instructing the provider computing system 242 to process or stop the transaction.

The provider computing system determines if the customer 110 approves the transaction, at 440. For example, the provider computing system 242 may determine from the transaction instruction if the customer 110 wants to continue processing the transaction or stop the transaction. In some arrangements, in response to determining that the customer approves the transaction, the provider computing system processes the transaction, at 445. Furthermore, the provider computing system may update a transaction database, at 485.

In response to determining that the customer does not approve the transaction, the provider computing system cancels the transaction, at 450. For example, the customer personnel may send a cancel transaction request to the provider computing system 242 via the mobile communication portal application 103 and/or the communication portal 218 instructing the provider computing system 242 to cancel the transaction or otherwise place the transaction on hold. The provider computing system generates a UAR, at 455. In some arrangements, the provider computing system (e.g., the provider computing system 242) may be configured to generate the UAR immediately after the transaction is stopped, for example after operation 420 or 425. In such arrangements, the fraud alert may include the UAR.

The provider computing system determines if the UAR is missing any information, at 460. For example, the UAR may initially be generated using information provided by the customer computing system 211, which may not include all the information corresponding to the transaction. If the provider computing system determines that the UAR is complete, the provider computing system transmits the UAR to the customer, at 470. In response to determining that the UAR is missing information, the provider computing system populates one or more blank fields of the UAR with complete transaction information obtained from analysis of the transaction history, at 465. The provider computing system transmits the complete UAR to the customer, at 470. For example, the provider computing system 242 may be configured to transmit the complete UAR to the communication portal 218 and/or the mobile communication portal application 103. In some arrangements, the provider computing system (e.g., the provider computing system 242) may also send the UAR to a fraud management department associated with provider computing system, at 475. Furthermore, the provider computing system may update an ongoing report or dashboard with the transaction, at 480. The provider computing system updates the transaction database, at 485.

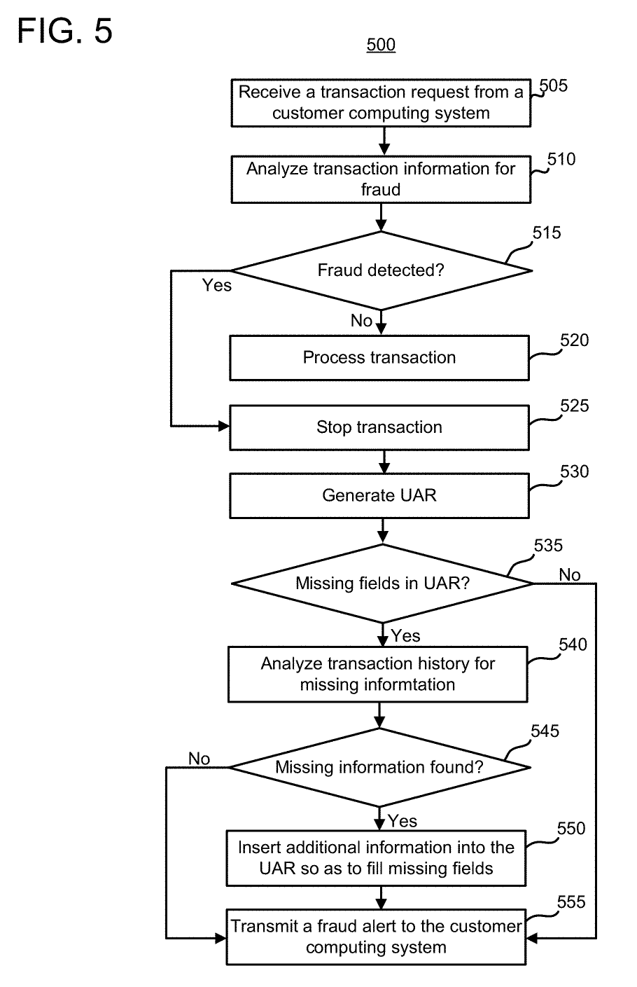

FIG. 5 is a flow diagram illustrating a method 500 for detecting fraud in a financial transaction, automatically generating a UAR and populating blank fields of the UAR with information not available in a transaction information associated with the transaction. In some arrangements, the method 500 may be executed using circuitry of the provider computing system 242 using information stored in the account database 250 and/or the transaction database 252. The method 500 is generally initiated when the provider computing system receives a transaction request from the customer computing system 211, at 505. The transaction includes a transaction information. For example, the user, or someone impersonating the user initiates a transaction with the customer computing system 211, and the customer computing system 211 transmits a transaction request including the transaction information to the provider computing system 242 to process the transaction.

The provider computing system determines a possible instance of fraud in the transaction based on a transaction history associated with the transaction and the transaction information, at 510. For example, the transaction database 252 of the provider computing system 242 may include additional information corresponding to the transaction which may not be available with the customer computing system 211, and therefore not provided in the transaction information. The additional information stored in the transaction database 252 may indicate that the transaction is possibly fraudulent. The provider computing system determines if fraud is detected, at 515. If no fraud is detected, the provider computing system processes the transaction, at 520. In response to determining that the transaction is possibly fraudulent, the provider computing system stops the transaction, at 525. In some arrangements, the provider computing system (e.g., the provider computing system 242) may continue to stop the transaction until a transaction instruction is received from the communication portal 218 or the mobile communication portal application 103 instructing the provider computing system 242 to at least one of proceed with the transaction or stop the transaction. In other arrangements, the provider computing system may be configured to stop the transaction for a predetermined time, as previously described herein. In such arrangements, the provider computing system may be configured to determine if a cancel transaction notification, for example included in the transaction instruction is received from the customer computing system (e.g., the customer computing system 211) within the predetermined time. In response to not receiving the cancel transaction notification from the customer computing system within the predetermined time, the provider computing system may be configured to process the transaction.

The provider computing system generates a UAR, at 530. The UAR may include information providing details of the transaction and reasons for flagging the transaction as possibly fraudulent. The provider computing system determines if the UAR includes any missing fields, at 535. If the UAR is complete or does not include any missing fields, the provider computing system transmits a fraud alert to a customer computing system, at 555. In some arrangements, the fraud alert may include the UAR. In other arrangements, the fraud alert may alternately or additional include at least one of a bank identifier message (e.g., SWIFT® message), a freeform, an inquiry, an email, a text and/or a phone call. In response to determining that the UAR includes missing fields, the provider computing system determines a transaction history for information corresponding to the transaction, at 540. For example, the provider computing system 242 may be configured to analyze the transaction history stored in the transaction database 252 corresponding to the customer 110, the originator of the transaction (e.g., the user) and/or the beneficiary of the transaction. In some arrangements the transaction information analyzed to determine a possibility of fraud in the transaction includes but is not limited to a name of the originator of the transaction, a name of the beneficiary of the transaction, a transaction origin location, a transaction destination location, spelling of data included in the complete transaction information, one or more fraudulent accounts associated with the transaction, a time zone of the transaction, contact information associated with transaction, originator account number, and beneficiary account number.

The provider computing system determines if information corresponding to the missing field is found, at 545. If no additional information is found, the method 500 proceeds to operation 555, and the fraud alert (e.g., the UAR) is sent to the customer computing system (e.g., the customer computing system 211). In response to finding information corresponding to the missing fields, the provider computing system automatically inserts additional information from the transaction database into the UAR so as to fill any missing fields of the UAR, at 550. This may generate a complete UAR including more detailed information regarding the transaction, then the information provided by the customer computing system. Furthermore, the complete UAR may be non-editable.

The provider computing system transmits the fraud alert to the customer computing system, at 555. For example, the provider computing system 242 may transmit the complete UAR to the customer computing system 211. In some arrangements, the provider computing system (e.g., the provider computing system 242) may transmit the fraud alert to a communication portal (e.g., the communication portal 218) associated with the customer computing system (e.g., the customer computing system 211) and/or a mobile communication portal application (e.g., the mobile communication portal application 103) associated with a personnel device (e.g., the personnel device 102) of a customer personnel (e.g., the customer personnel). In some arrangements, the provider computing system may update a transaction history of the customer associated with the customer computing system 211 and/or an the originator of the transaction (e.g., the user) using information from the complete UAR. In other arrangements, the provider computing system may update an outgoing report and/or a dashboard from the complete UAR. In still other arrangements, the provider computing system may transmit the fraud alert (e.g., the complete UAR) to the fraud management department associated with the provider computing system (e.g., the provider computing system 242).

It should be noted that the terms “example,” or “exemplary” as used herein to describe various arrangements are intended to indicate that such arrangements are possible examples, representations, and/or illustrations of possible arrangements (and such term is not intended to connote that such arrangements are necessarily extraordinary or superlative examples).

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuitry,” or “circuit” may include hardware structured to execute the functions described herein. In some arrangements, each respective “circuit” or “circuitry” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit” or “circuitry.” In this regard, the “circuit” or “circuitry” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuitry,” or “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” “or “circuitry” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should also be noted that the term “input devices,” as described herein, may include any type of input device including, but not limited to, a keyboard, a keypad, a mouse, joystick, touch sensitive screen or other input devices performing a similar function. Comparatively, the term “output device,” as described herein, may include any type of output device including, but not limited to, a computer monitor, printer, facsimile machine, or other output devices performing a similar function.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and

While this specification contains many specific implementation details, these should not be construed as limitations on the scope of any arrangement or of what may be claimed, but rather as descriptions of features specific to particular implementations of particular arrangements. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method of analyzing fraud in a transaction, the method comprising:
receiving, by a provider computing system from a customer computing system, a transaction request for processing the transaction, the transaction including a transaction information;
determining, by the provider computing system using information stored in a transaction database, that the transaction information is complete transaction information;
determining, by the provider computing system, a transaction history associated with a party to the transaction request, wherein a portion of the transaction history is not accessible by the customer computing system;
determining, by the provider computing system, a possible instance of fraud in the transaction based on the transaction history and the complete transaction information;
generating, by the provider computing system, an unusual activity report;
populating, by the provider computing system, a blank field of the unusual activity report, based on the transaction history and the complete transaction information; and
transmitting, by the provider computing system to the customer computing system, a fraud alert,
wherein the fraud alert is displayed at least on a personnel device of a customer personnel associated with the customer computing system.

2. The method of claim 1, further comprising:
prior to determining that the transaction information is complete transaction information, determining the transaction information is incomplete; and
automatically inserting, by the provider computing system using information stored in the transaction database, additional information into the transaction information so as to generate the complete transaction information.

3. The method of claim 1, wherein the customer computing system is associated with a foreign financial institution.

4. The method of claim 1, wherein the complete transaction information comprises at least one of a name of the originator of the transaction, a name of the beneficiary of the transaction, a transaction origin location, a transaction destination location, a spelling of data included in the complete transaction information, one or more fraudulent accounts associated with the transaction, a time zone of the transaction, a contact information associated with transaction, an originator account number, or a beneficiary account number.

5. The method of claim 1, further comprising:
in response to determining that there is a possible instance of fraud in the transaction, stopping, by the provider computing system, the transaction for a predetermined time;
determining, by the provider computing system, if a cancel transaction notification is received by the provider computing system from the customer computing system within the predetermined time; and
in response to not receiving the cancel transaction notification within the predetermined time, processing, by the provider computing system, the transaction.

6. The method of claim 1, wherein the fraud alert comprises the unusual activity report.

7. The method of claim 1, further comprising:
linking, by the provider computing system, the customer computing system associated and the provider computing system with a unique code associated with the transaction.

8. The method of claim 7, wherein the unique code includes at least one of a customer identifier code or a transaction number.

9. The method of claim 1, wherein the fraud alert comprises at least one of a customer identifier code message, a freeform alert or an inquiry.

10. The method of claim 1, wherein the unusual activity report is non-editable.

11. The method of claim 1, further comprising:
updating, by the provider computing system from the complete transaction information, a transaction history of at least one of a customer associated with the customer computing system or an originator of the transaction.

12. The method of claim 1, further comprising:
updating, by the provider computing system with the complete transaction information, at least one of an outgoing report and a dashboard.

13. The method of claim 1, further comprising:
transmitting, by the provider computing system to a communication portal associated with the customer computing system, the fraud alert.

14. The method of claim 13, further comprising:
receiving, by the provider computing system from the communication portal, a transaction instruction instructing the provider computing system to at least one of proceed with the transaction or stop the transaction.

15. The method of claim 1, further comprising:
transmitting, by the provider computing system to a fraud management department associated with provider computing system, the fraud alert.

16. A provider computing system, comprising:
a network interface structured to facilitate data communication via a network;
a memory; and
a processing circuit comprising a processor, the processing circuit configured to:
receive, from a customer computing system, a transaction request for processing a transaction, the transaction including a transaction information;
determine, using information stored in a transaction database, that the transaction information is incomplete;
automatically insert, using information stored in the transaction database, additional information into the transaction information so as to generate a complete transaction information;
determine a possible instance of fraud in the transaction from a transaction history associated with the transaction, and the complete transaction information;
stop the transaction; and
transmit, to the customer computing system, a fraud alert, the fraud alert being displayed at least on a personnel device of a customer personnel associated with the customer computing system.

17. The provider computing system of claim 16, wherein the complete transaction information comprises at least one of a name of the originator of the transaction, a name of the beneficiary of the transaction, a transaction origin location, a transaction destination location, a spelling of data included in the complete transaction information, one or more fraudulent accounts associated with the transaction, a time zone of the transaction, a contact information associated with transaction, an originator account number, or a beneficiary account number.

18. The provider computing system of claim 16, wherein the processing circuit is further configured to:
in response to determining the possible instance of fraud in the transaction, stop the transaction for a predetermined time;
determine if a cancel transaction notification is received from the customer computing system within the predetermined time; and
in response to not receiving the cancel transaction notification within the predetermined time, process the transaction.

19. The provider computing system of claim 16, wherein the processing circuit is further configured to:
link the customer computing system and the provider computing system with a unique code associated with the transaction.

20. The provider computing system of claim 16, wherein the processing circuit is further configured to:
generate an unusual activity report;
populate a blank field of the unusual activity report, based on additional information included in the complete transaction information; and
transmit by the provider computing system to the customer computing system, a fraud alert.

21. The provider computing system of claim 16, wherein the processing circuit is further configured to:
update, from the complete transaction information, a transaction history of at least one of a customer associated with the customer computing system or an originator of the transaction.

22. The provider computing system of claim 16, wherein the processing circuit is further configured to:
transmit, to a communication portal associated with the customer computing system, the fraud alert.

23. The provider computing system of claim 22, wherein the processing circuit is further configured to:
receive, from the communication portal, a transaction instruction instructing the provider computing system to at least one of proceed with the transaction or stop the transaction.

24. A non-transitory processor-readable medium having processor-readable instructions stored thereon, such that when executed by a processor of a provider computing system, cause the provider computing system to perform operations, the operations comprising:
receive from a customer computing system, a transaction request for processing a transaction, the transaction including a transaction information;
determine using information stored in a transaction database, the transaction information is complete transaction information;
determine a transaction history associated with a party to the transaction request, wherein a portion of the transaction history is not accessible by the customer computing system;
determine a possible instance of fraud in the transaction based on the complete transaction information;
generate an unusual activity report;
populate a blank field of the unusual activity report, based on the transaction history and the complete transaction information; and
transmit to the customer computing system, a fraud alert the fraud alert being displayed at least on a personnel device of a customer personnel associated with the customer computing system.

25. A method of analyzing and reporting fraud in a transaction, the method comprising:
receiving, by a provider computing system from a customer computing system, a transaction request for processing a transaction, the transaction including a transaction information;
determining, by the provider computing system from the transaction information and a transaction history associated with the transaction, a possible instance of fraud;
in response to determining that the transaction is possibly fraudulent, stopping, by the provider computing system, the transaction;
generating, by the provider computing system, an unusual activity report;
determining, by the provider computing system, if the unusual activity report includes missing fields;
in response to determining that the unusual activity report includes missing fields, determining, by the provider computing system from the transaction history, information corresponding to the missing fields;
inserting, by the provider computing system from the transaction history, additional information into the unusual activity report so as to fill any missing fields of the unusual activity report; and
transmitting, by the provider computing system to the customer computing system, the unusual activity report,
wherein the unusual activity report is displayed at least on a personnel device of a customer personnel associated with the customer computing system.

26. The method of claim 25, wherein the unusual activity report is non-editable.

27. The method of claim 25, further comprising:
transmitting, by the provider computing system to the customer computing system, a fraud alert,
wherein the fraud alert is displayed at least on a personnel device of a customer personnel associated with the customer computing system.

28. The method of claim 27, further comprising:
transmitting, by the provider computing system to a communication portal associated with the customer computing system, the fraud alert.

29. The method of claim 27, further comprising:
in response to determining the possible instance of fraud in the transaction, stopping, by the provider computing system, the transaction for a predetermined time;
determining, by the provider computing system, if a cancel transaction notification is received by the provider computing system from the customer computing system within the predetermined time; and
in response to not receiving the cancel transaction notification, processing, by the provider computing system, the transaction.

30. The method of claim 25, further comprising:
updating, by the provider computing system from the unusual activity report, a transaction history of at least one of a customer associated with the customer computing system or an originator of the transaction.

31. The method of claim 25, further comprising:
updating, by the provider computing system from the unusual activity report, at least one of an outgoing report or a dashboard.

32. The method of claim 31, further comprising:
receiving, by the provider computing system from the communication portal, a transaction instruction instructing the provider computing system to at least one of proceed with the transaction or stop the transaction.

33. The method of claim 25, further comprising:
transmitting, by the provider computing system to a fraud management department associated with provider computing system, a fraud alert.
